(19) United States
(12) Patent Application Publication
(10) Pub. No.: US 2007/0178843 A1
(43) Pub. Date: Aug. 2, 2007

(54) Automated testing of a handheld device over a network

(75) Inventors: Stephen Singh, Westford, MA (US); Devang Shah, Ashland, MA (US); Paul Gallagher, South Easton, MA (US); Pradeep Phatak, Buffalo, NY (US); Anubhav Jindal, Levittown, NY (US)

Correspondence Address: PROSKAUER ROSE LLP, ONE INTERNATIONAL PLACE 14TH FL, BOSTON, MA, 02110, US

(73) Assignee: FMR Corp., Boston, MA (US)

(21) Appl. No.: 11/344,940

(22) Filed: Feb. 1, 2006

(51) Int. Cl. H04B 17/00; H04Q 7/20

(52) U.S. Cl. 455/67.11; 455/423

(57) ABSTRACT

Described are methods and apparatus, including computer program products, for automated testing of a handheld device over a network. A first predefined test is executed on a handheld device to generate a first element with a first predefined value for a first parameter associated with the first element and the first element is transmitted over a communication network to a desktop computing device. Receipt of the first element is verified at the desktop computing device. Also verified is that the first parameter associated with the first element has the first predefined value.

### FIELD OF THE INVENTION

The present invention relates to automated testing of a handheld device over a network.

### BACKGROUND

Our society is increasingly becoming more mobile with the wider availability and an increasing reliance on wireless handheld devices. Professionals use wireless handheld devices to maintain contact with their office while they are traveling or are out of the office. These handheld devices include personal information manager (PIM) application software that organizes and/or monitors personal information, such as one or more of the following: address books, calendars, task lists, notes and the like. Most of these handheld devices can also receive emails. These handheld devices can also synchronize the required data (e.g., PIM data and emails) with a user's desktop computer, so that the user remains organized and in communication with others, and sees the same data, whether that user is working on the user's desktop or the user's handheld device.

A company that provides and/or supports handheld devices used by their employees typically has a network infrastructure to support the use of the devices. For example, a company that supports BlackBerry® devices by Research In Motion, LTD (RIM) has a BlackBerry® Exchange Server (BES) that communicates with a Microsoft® Exchange Server to synchronize Outlook® data from a user's desktop with data on the user's BlackBerry® device. Typically, a user can only test the network and the handheld device interaction by manually performing tasks with the handheld device when it is in communication with the network, with the user ascertaining that the task was completed successfully. If different features need to be tested, the user has to perform several tasks (e.g., data entries) to ensure all of the features operate as expected. For example, one company has developed a suite of nearly 200 tests to verify that each of the features of a particular BlackBerry® device work as expected on the company network. A user performs these tests by manually entering a particular sequence of data for each test. In this example, the suite of manual tests takes a user about a week to complete.

### SUMMARY OF THE INVENTION

In general overview, there are techniques for automated testing of a handheld device over a network. The techniques can include methods and systems, including computer program products. In one aspect, there is a method. A first predefined test is executed on a handheld device to generate a first element with a first predefined value for a first parameter associated with the first element and the first element is transmitted over a communication network to a desktop computing device. Receipt of the first element is verified at the desktop computing device. Also verified is that the first parameter associated with the first element has the first predefined value.

In another aspect, there is a system that includes a desktop computing device. The desktop computing device is configured to receive a first element over a communication network from a handheld device, where the first element is generated from a first predefined test executed on the handheld device and has a first predefined value for a first parameter associated with the first element. The desktop computing device also is configured to verify receipt of the first element at the desktop computing device and that the first parameter associated with the first element has the first predefined value.

In another aspect, there is a system that includes a handheld device. The handheld device is configured to execute a first predefined test to generate a first element with a first predefined value for a first parameter associated with the first element and to transmit the first element over a communication network to a desktop computing device. The handheld device also is configured to verify receipt of a second element generated by the desktop computing device and that a second parameter associated with the second element has a second predefined value.

In another aspect, there is a system for automated testing of a handheld device over a network. The system includes a means for executing, on a handheld device, a first predefined test to generate a first element with a first predefined value for a first parameter associated with the first element. The system also includes a means for transmitting the first element over a communication network to a desktop computing device. The system also includes a means for verifying receipt of the first element at the desktop computing device and that the first parameter associated with the first element has the first predefined value.

In another aspect, there is a computer program product, tangibly embodied in an information carrier, for automated testing of a handheld over a network. The computer program product includes instructions being operable to cause data processing apparatus to execute on a handheld device a first predefined test to generate a first element with a first predefined value for a first parameter associated with the first element. The computer program product also includes instructions being operable to cause data processing apparatus to transmit the first element over a communication network to a desktop computing device. The computer program product also includes instructions being operable to cause data processing apparatus to verify receipt of the first element at the desktop computing device and that the first parameter associated with the first element has the first predefined value.

Any of the aspects can include one or more of the following features. There can be a second predefined test to generate a second element with a second predefined value for a second parameter associated with the second element. The second predefined test can be executed on the desktop computing device. The second element is transmitted over a network to the handheld device. Receipt of the second element is verified at the handheld device. Also verified is that the second parameter associated with the second element has the second predefined value.

There can be a second predefined test to generate a second element with a second predefined value for a second parameter associated with the second element that is executed on the handheld device. In such an example, the second element is transmitted over a network to desktop computing device. Receipt of the second element is verified at the desktop computing device. Also verified is that the second parameter associated with the second element has the second predefined value.

There can be a second predefined test to modify the first element by changing the first parameter associated with the first element to a second predefined value. This test can be executed on the handheld device. The modified first element is transmitted over a network to desktop computing device. Receipt of the modified first element is verified at the desktop computing device. Also verified is that the first parameter associated with the first element has the second predefined value.

In any of these predefined tests, the first element can include a calendar entry, where the first parameter is associated with time. There can be an indication to the desktop computing device that the first predefined test has been executed. To perform the indicating, a graphical user interface can be employed on the desktop computing device. The first element can include an email, a contact, a task, a note, a calendar entry, or any combination thereof. The first element can include an element of a Microsoft® Outlook® application program. The first predefined test can include a platform neutral instruction set. The first predefined test can include a JAVA applet. The first predefined test can include an instruction set to interface with an application program interface (API) of an operating system included on the handheld device. The operating system (OS) included on the handheld device comprises Palm OS, Windows Mobile® (Pocket PC) OS, BlackBerry® OS, Symbian OS™, or any combination thereof. The verification can include interfacing with an application program interface (API) of an application program included on the desktop computing device, where the application program is associated with the first element. The handheld device can include a RIM BlackBerry® device, a Palms PDA device, a mobile telephony device, a handheld device simulator application program, or any combination thereof. The network can include a server represented using a server simulator application program. The results of verifying can be displayed employing a graphical user interface on the desktop computing device, the handheld device, or both.

Any of the above examples can include one or more of the following advantages. The automated process can eliminate human error in the testing process. The automated process can reduce the testing time, for example, enabling a user to perform the test suite of nearly 200 tests in less than one day. One implementation of the invention may provide all of the above advantages.

The details of one or more examples are set forth in the accompanying drawings and the description below. Further features, aspects, and advantages of the invention will become apparent from the description, the drawings, and the claims.

### BRIEF DESCRIPTION OF THE DRAWINGS

FIG. 1 is a block diagram showing a network over which a handheld device synchronizes with a desktop computing device.

FIG. 2 is a flow diagram showing a process in which a handheld device synchronizes with a desktop computing device.

FIG. 3 is a flow diagram showing another process in which a handheld device synchronizes with a desktop computing device.

FIG. 4 shows a GUI displayed on a desktop computing device.

FIG. 5 shows a screen shot on a handheld device.

FIG. 6 shows another screen shot on a handheld device.

FIG. 7 is a block diagram showing a network over which a simulated handheld device and/or a simulated server are used to synchronize with a desktop computing device.

### DETAILED DESCRIPTION

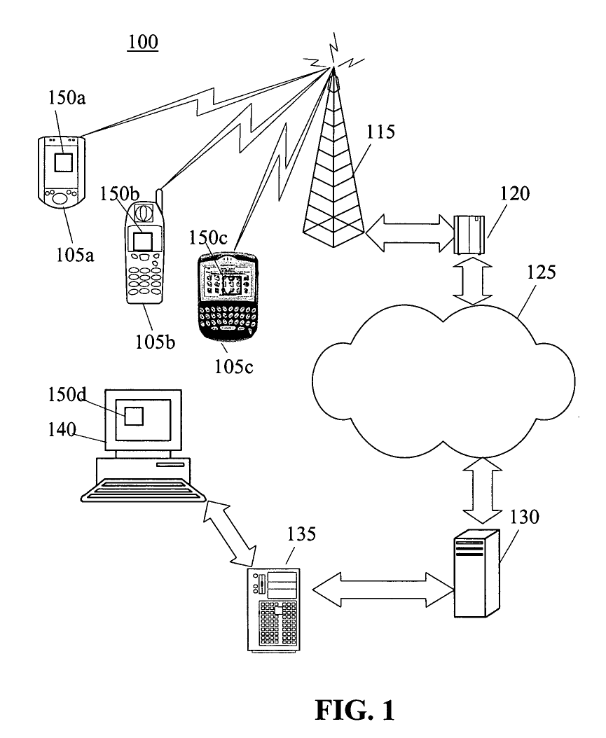

FIG. 1 illustrates an exemplary system 100 for automated testing of a handheld device over a network. The system 100 includes a variety of handheld devices 105a, 105b, and 105c, generally referred to as 105. The handheld devices 105 can include PDAs, telephony devices, and/or other types of handheld computing devices. One example of a handheld device 105 is a BlackBerry® device by RIM®. Other examples are applicable and described below. The handheld devices 105 wirelessly communicate with a transceiver. An antenna 115 receives/transmits the wireless signals from/to the wireless devices 105. The antenna transmits/receives signals, either wirelessly or through a cable (e.g., copper or optical), to/from a component 120. The component 120 of the transceiver depends upon the type of network with which the handheld device communicates. For example, in telephony-based wireless devices, the component 120 can be a base station. In an 802.11 network, the component 120 can be a bridge and/or router. Other network types are applicable. The component 120 communicates the signals over a communications network 125 to a private company network that the component 120 accesses through a firewall 130. The firewall 130 communicates the signals to one or more servers, shown a server 135. Although only one server is depicted, the server 135 represents one or more of the servers used in a company network to support a network of internal devices (e.g., a desktop computing device 140) and communication with external networks, such as the communication network 125. For example, the server 135 can include Web servers, authentication servers, application servers, gateways, and the like. To perform automated testing of the handheld devices 150 over a network, which in system 100 includes the communication path between the handheld devices 150 and the desktop computing device 140, the handheld devices 150 and the desktop computing device 140 each have an set of instructions 150a, 150b, 150c and 150d, generally referred to as 150. In general overview, the set of instructions 150 generate and/or modify different PIM and email elements with predefined values of certain parameters of those elements on one of the devices (e.g., the handheld device 150 or the desktop device 140) and verify the synchronization of those generated/modified elements with the device on the other end of the network (e.g., the desktop device 140 or the handheld device 150). In some examples, the set of instructions 150a, 150b, 150c, and 150d are identical. In other examples, the set of instructions 150a, 150b, 150c and 150d vary based on, for example, location and/or device type.

In a location variation, the set of instructions 150 perform certain tests and verifications if it is located in a handheld device 150, and performs different tests and verifications if it is located in the computing device 140. For example, for a first predefined test on the handheld device 150 that generates a PIM or an email element on that handheld, the desktop computing device 140 has a corresponding verification instruction set to verify that first predefined test generated element is synchronized with the desktop computing device 140. Similarly, for an exemplary second predefined test on the desktop device 140 that generates a PIM or an email element on that desktop device 140, the handheld device 105 has a corresponding verification instruction set to verify that second predefined test generated element is synchronized with the handheld device 105.

In a device variation, each set of instructions 150a, 150b, 150c, and/or 150d may perform the same functions, but are written differently (e.g., different methods and/or variables) to correspond with the device in which the set of instructions 150 is executed. For example, the operating system software of each device 105a, 105b, 105c, and 105d can be different and have different APIs, and require different sets of instructions 150 to interface with those different operating systems and/or APIs.

In the system 100, it can be seen that the tests of a test suite not only test the features of the handheld devices 105 and the desktop computing devices 140, but also test the network (and/or network elements) over which the communication occurs. Many times, there are one or more servers 135 in a corporation's private network to support handheld devices 105. For example, for supporting BlackBerry® handheld devices, an enterprise can have a BlackBerry® Exchange Server (BES) (e.g., as one or the servers represented by the server 135). If an enterprise uses Microsoft® Outlook® application software for email and PIM data, the enterprise can have a Microsoft® Exchange Server (e.g., as one or the servers represented by the server 135). As the software versions change on these required servers, or other network elements involved in the synchronization between devices, the test suite can be executed quickly and automatically to ensure that a software upgrade is compatible with the handheld devices being used by the employees, and that there is no interruption of the use of those handheld devices.

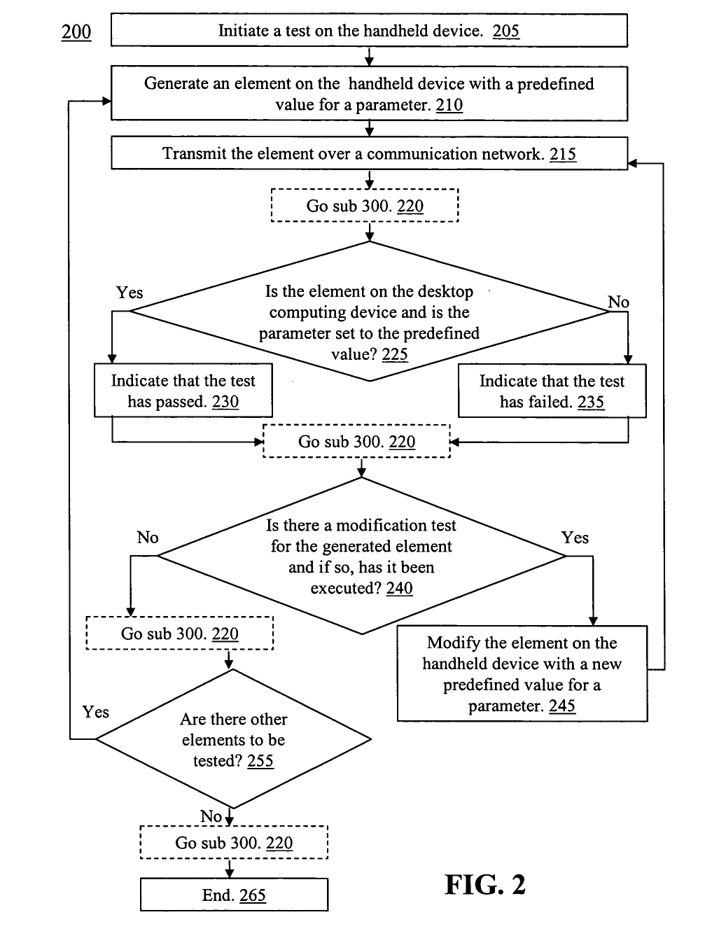

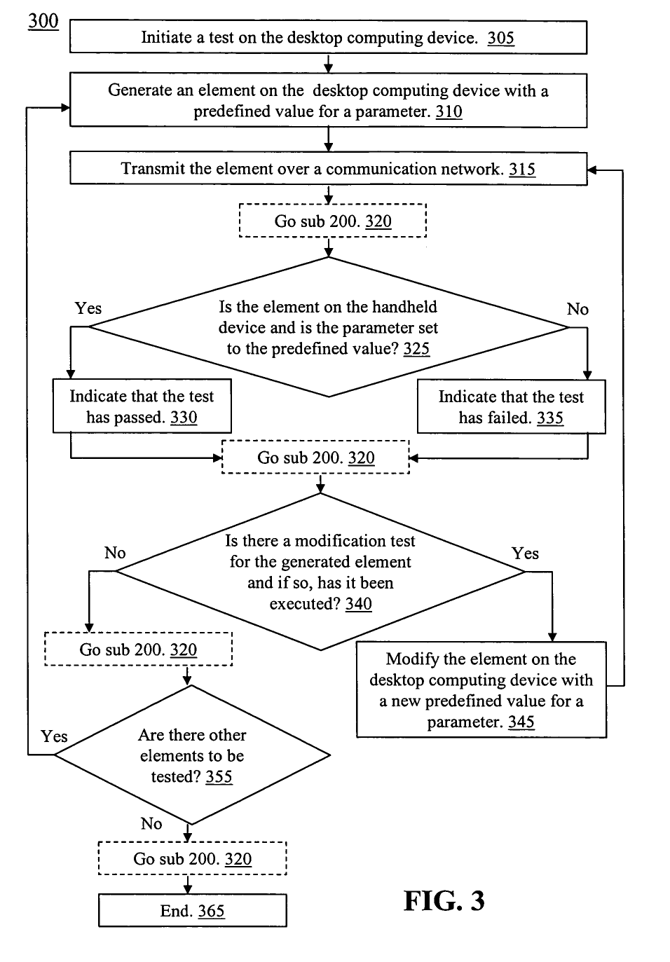

FIGS. 2 and 3 illustrate exemplary processes for executing and verifying tests on the handheld and desktop devices. FIG. 2 illustrates a process 200 in which the set of instructions 150 generate and/or modify elements on the handheld device 105 and verify those elements and/or modifications on the desktop computing device 140. FIG. 3 illustrates a process 300 in which the set of instructions 150 generate and/or modify elements on the desktop computing device 140 and verify those elements and/or modifications on the handheld device 105.

In FIG. 2, the process 200 includes initiating a test on the handheld device 105 (205). The initiated test includes a set of instructions (e.g., a portion of the set of instructions 150) that generates a new element (e.g., a PIM element, such as a calendar entry or contact entry, and/or an email message) on the handheld device 105 (210). When generating the new element, the test sets one or more parameters of that element to predefined values (e.g., a contact element with a value for the first name field equal to “John”) (210). The use of predefined values enables verification on the desktop computing device 140. It is worth noting that the predefined value can be relative, such as a date field being assigned a relative value of tomorrow or next month. The handheld device 105 transmits the element over a communication network (215). For example, a user can configure the handheld device 105 for wireless synchronization with its owner's desktop PIM application. With such configuration, the handheld device 105 synchronizes any new entries or modifications with the owner's desktop PIM application over a network with a wireless portion (e.g., system 100).

In the process 200, there are many optional “Go sub 300” elements (220), which represent that at many points in the process 200. The process flow (e.g., testing) can optionally transfer to a part of the process 300, and then come back to the process 200. In other words, the order of when tests are performed on the handheld device 105 and the desktop computing device 140 is not important and can vary. Except for having to first generate or modify an element before that element or its modification can be verified, the order of test on the handheld device 105 and the desktop device 140 can be as preferred by the user and/or established by the full set of instructions 150. Although shown in specific locations in the process 200, the elements 220 can be located anywhere in the process 200.

In the process 200, after the handheld device 105 transmits the generated element over a network, the desktop computing device 140 verifies that the element is found on the computing device 140 (225). For example, if the test on the handheld device 105 is to create a calendar element, the set of instructions 150d on the desktop computing device 140 verifies that the calendar element appears in the PIM-related application data on the desktop computing device 140 (225). In addition to verifying that the calendar element appears in the PIM-related application data, the set of instructions 150d on the desktop computing device 140 verifies that the calendar element includes the predefined values that the test on the handheld device 105 used (225). For example, in the newly generated calendar element is for tomorrow, 10:00-11:00 with John Smith in conference room 10-3, the set of instructions 150d on the desktop computing device 140 verifies that the calendar entry includes those values. If the test element exists and the values are correct, the set of instructions 150d on the desktop computing device 140 indicates that the test has passed (230). If the test element does not exist and/or the values are not correct, the set of instructions 150d on the desktop computing device 140 indicates that the test has failed (235).

Once an element has been generated, the set of instructions 150 determines whether some tests exist that modify some of the parameters of that generated element (240). If a modification test exists, the set of instructions (e.g., a portion of the set of instructions 150) modifies one or more values of one or more parameters of the generated element (e.g., the time of a calendar entry is modified from 10:00-11:00 to 1:00-2:00) on the handheld device 105 (245). The handheld device 105 transmits this modification over the communication network (215). The set of instructions 150d on the desktop computing device 140 verifies that the calendar entry includes the modified time values (225).

If no modification tests exist or if they have all been executed, the set of instructions 150 determines if there are any other elements to be tested (255). If so, then the processes described above are repeated for additional elements (e.g., email, other PIM elements, such as tasks and contacts, and the like). If all of the tests have been performed, process 200 ends (265).

The process 300 of FIG. 3 is similar to the process 200, except the elements are generated and/or modified on the desktop computing device 140 and verified on the handheld device 105. Through the use of both the processes 200 and 300, synchronization is verified in both directions. The process 300 includes initiating a test on the desktop computing device 140 (305). The initiated test includes a set of instructions (e.g., a portion of the set of instructions 150) that generates a new element (e.g., a PIM element, such as a calendar entry or contact entry, and/or an email message) on the desktop computing device 140 (310). When generating the new element, the test sets one or more parameters of that element to predefined values (e.g., a contact element with a value for the first name field equal to “John”) (310). The use of predefined values enables verification on the handheld device 150. The predefined value can be relative, such as a date field being assigned a relative value of tomorrow or next month. The desktop computing device 140 transmits the element over a communication network (315). For example, a user can configure the desktop computing device 140 for wireless synchronization with its owner's handheld PIM application. With such configuration, any new entries or modifications are synchronized with the owner's handheld PIM application over a network with a wireless portion (e.g., system 100). The desktop computing device 140 does not have to transmit the new entries or modifications directly. For example, the desktop computing device 140 can update an application server (e.g., the server 135) with the new data. Upon receiving the updates, the application server can initiate the synchronization process with the handheld device 105, which may include using other servers in the company network.

In the process 200, there are many optional “Go sub 200” elements (320), which represent that at many points in the process 300, the process flow (e.g., testing) can optionally transfer to a part of the process 200, then come back to the process 300. In other words, the order of when tests are performed on the handheld device 105 and the desktop computing device 140 is not important and can vary. Except for having to first generate or modify an element before that element or its modification can be verified, the order of test on the handheld device 105 and the desktop device 140 can be as preferred by the user and/or established by the full set of instructions 150. Although shown in specific locations in the process 300, the elements 320 can be located anywhere in the process 300.

In the process 300, after the generated element has been transmitted over a network, the handheld device 105 verifies that the element is found on the handheld device 105 (325). For example, if the test on the desktop computing device 140 is to create a calendar element, the set of instructions 150 on the handheld device 105 verifies that the calendar element appears in the PIM-related application data on the handheld device 105 (325). In addition to verifying that the calendar element appears in the PIM-related application data, the set of instructions 150 on the handheld device 105 verifies that the calendar element includes the predefined values that the test on the desktop computing device 140 used (325). For example, in the newly generated calendar element is for tomorrow, 10:00-11:00 with John Smith in conference room 10-3, the set of instructions 150 on the handheld device 105 verifies that the calendar entry includes those values. If the test element exists and the values are correct, the set of instructions 150 on the handheld device 105 indicates that the test has passed (330). If the test element does not exist and/or the values are not correct, the set of instructions 150 on the handheld device 105 indicates that the test has failed (335). In other examples, the pass and fail indications of the processes 200 and 300 can be combined onto a single device. For example, the handheld device 105 can display all of the pass/fail indications of the processes 200 and 300 and/or the desktop computing device 140 can display all of the pass/fail indications of the processes 200 and 300.

Once an element has been generated, the set of instructions 150 determines whether some tests exist that modify some of the parameters of that generated element (340). If a modification test exists, the set of instructions (e.g., a portion of the set of instructions 150) modifies one or more values of one or more parameters of the generated element (e.g., the time of a calendar entry is modified from 10:00-11:00 to 1:00-2:00) on the desktop computing device 140 (345). This modification is transmitted over the communication network (315). The set of instructions 150 on the handheld device 105 verifies that the calendar entry includes the modified time values (325).

If no modification tests exist or if they have all been executed, the set of instructions 150 determines if there are any other elements to be tested (355). If so, then the processes described above are repeated for additional elements (e.g., email, other PIM elements, such as tasks and contacts, and the like). If all of the tests have been performed, process 300 ends (365). Table 1 illustrates some exemplary tests that can be included in a test suite in the set of instructions 150. The “Device” column indicates the device (e.g., one of the handheld devices 105, the desktop computing device 140) on which the test element is generated or modified. As noted in the “Device” column for tests 55 and 56, if a user uses delegate functionality, that functionality can also be tested to ensure the delegate functionality performs as expected with the use of a handheld device 105 over the network. The test numbers are provided for a quick reference for use herein. The “Test Element” column indicates what type of element is being tested. The “Test” column provides a title and/or description of the test. The “Test Parameter” column indicates the parameter of the test element that is used (e.g., set or modified) for that test. In some cases, to provide some examples, the “Test Parameter” column also includes the predefined value to which the parameter is set and/or modified. Table 1 shows some examples of tests and of course other test elements and parameters can be included in a test suite, so that all of the available test elements and all of the test parameters available for all of the test elements

TABLE 1

| Device | Test # | Test Element | Test | Test Parameter |
|---|---|---|---|---|
| Desktop | 1 | Email | Create Self Addressed Email | To Field |
| Device | | | Message | |
| Desktop | 2 | Email | Create Self Addressed Email | Cc Field |
| Device | | | Message | |
| Desktop | 3 | Email | Create Self Addressed Email | Sensitivity, |
| Device | | | Message | value = Personal |
| Desktop | 4 | Email | Create Self Addressed Email | Sensitivity, |
| Device | | | Message | value = Private |
| Desktop | 5 | Email | Create Self Addressed Email | Sensitivity, |
| Device | | | Message | value = |
| | | | | Confidential |
| Desktop | 6 | Email | Create Self Addressed Email | Attachment: |
| Device | | | Message | Spreadsheet |
| | | | | Document |
| Handheld | 7 | Email | Create Self Addressed Email | To Field |
| Device | | | Message | |
| Handheld | 8 | Email | Create Self Addressed Email | Bcc Field |
| Device | | | Message | |
| Handheld | 9 | Email | Create Self Addressed Email | Importance, |
| Device | | | Message | value = Low |
| Handheld | 10 | Email | Create Self Addressed Email | Importance, |
| Device | | | Message | value = High |
| Handheld | 11 | Email | Create Self Addressed Email | Search Name |
| Device | | | Message | |
| Handheld | 12 | Email | Create Self Addressed Email | Search Subject |
| Device | | | Message | |
| Handheld | 13 | Email | Mark As Read Self Addressed | Read/Unread |
| Device | | | Email Message | flag |
| Desktop | 14 | Email | Mark As Unread Self | Read/Unread |
| Device | | | Addressed Email Message | flag |
| Desktop | 15 | Email | Move Inbox Subfolder within | Mail folder |
| Device | | | Outlook | association |
| Handheld | 16 | Email | Delete Self Addressed Email | Deletion of an |
| Device | | | Message | element |
| Handheld | 17 | Contact | Create New Contact and | Existence of new |
| Device | | | Synchronize | element |
| Handheld | 18 | Contact | Modify Contact First Name | Contact's first |
| Device | | | Field and Synchronize | name field |
| Handheld | 19 | Contact | Modify Contact's Mobile Field | Contact's mobile |
| Device | | | and Synchronize | number field |
| Handheld | 20 | Contact | Modify Contact's Address 1 | Contact's |
| Device | | | Field and Synchronize | address 1 field |
| Handheld | 21 | Contact | Modify Contact's User 1 Field | Contact's user 1 |
| Device | | | and Synchronize | field |
| Desktop | 22 | Contact | Create New Contact and | Existence of new |
| Device | | | Synchronize | element |
| Desktop | 23 | Contact | Modify Contact's Job Title | Contact's job |
| Device | | | field and Synchronize | title field |
| Desktop | 24 | Contact | Modify Contact's Company | Contact's |
| Device | | | field and Synchronize | company field |
| Desktop | 25 | Contact | Modify Contact's Zip/Postal | Contact's |
| Device | | | Code Field and Synchronize | zip/postal code |
| | | | | field |
| Desktop | 26 | Contact | Modify Contact's | Contact's |
| Device | | | Country/Region Field and | country/region |
| | | | Synchronize | field |
| Desktop | 27 | Contact | Modify Contact's Email field | Contact's email |
| Device | | | and Synchronize | field |
| Desktop | 28 | Contact | Modify Contact's Notes Field | Contact's notes |
| Device | | | and Synchronize | Field |
| Desktop | 29 | Contact | Delete Contact and | Deletion of an |
| Device | | | Synchronize | element |
| Handheld | 30 | Task | Create New Task and | Existence of new |
| Device | | | Synchronize | element |
| Handheld | 31 | Task | Modify Task Subject Field and | Subject field |
| Device | | | Synchronize | |
| Handheld | 32 | Task | Modify Task Status Field/In | Status field |
| Device | | | Progress and Synchronize | value = In |
| | | | | Progress |
| Handheld | 33 | Task | Modify Task Priority | Priority field, |
| Device | | | Field/High and Synchronize | value = High |
| Handheld | 34 | Task | Modify Task Due/Date and | Due date field |
| Device | | | Synchronize | |
| Desktop | 35 | Task | Create New Task and | Existence of new |
| Device | | | Synchronize | element |
| Desktop | 36 | Task | Modify Task's Status Field To | Status field, |
| Device | | | Completed and Synchronize | value = |
| | | | | Completed |
| Desktop | 37 | Task | Modify Task's Priority Field | Priority field, |
| Device | | | To Low and Synchronize | value = Low |
| Desktop | 38 | Task | Delete Task and Synchronize | Deletion of an |
| Device | | | | element |
| Desktop | 39 | Recurring | Create Recurring Task and | Existence of new |
| Device | | Task | Synchronize | element |
| Handheld | 40 | Memopad | Create New Memopad and | Existence of new |
| Device | | | Synchronize | element |
| Handheld | 41 | Memopad | Modify Memopad's Title and | Title |
| Device | | | Synchronize | |
| Desktop | 42 | Memopad | Create Note and Synchronize | Existence of new |
| Device | | | | element |
| Handheld | 43 | Calendar | Create A New Appointment | Existence of new |
| Device | | | | element |
| Handheld | 44 | Calendar | Modify Appointment's | Location |
| Device | | | Location Field | |
| Handheld | 45 | Calendar | Modify Appointment's All | All Day Event |
| Device | | | Day Event Field | |
| Handheld | 46 | Calendar | Modify Appointment's | Duration |
| Device | | | Duration | |
| Handheld | 47 | Calendar | Modify Appointment's | Recurrence/ |
| Device | | | Recurrence/Monthly | Monthly |
| Handheld | 48 | Calendar | Modify Recurring Meeting | Start Time |
| Device | | | Instance Start Time | |
| Handheld | 49 | Calendar | Delete Recurring Meeting | Deletion of an |
| Device | | | Series | element |
| Desktop | 50 | Calendar | Create A New Appointment | Existence of new |
| Device | | | | element |
| Desktop | 51 | Calendar | Modify Appointment And | Attendee |
| Device | | | Invite Attendee | |
| Desktop | 52 | Calendar | Modify Appointments Start | Start Time |
| Device | | | Time Field | |
| Desktop | 53 | Calendar | Modify Appointments End | End Time |
| Device | | | Time Field | |
| Desktop | 54 | Calendar | Modify Appointments and | Attendee |
| Device | | | Remove Attendee | |
| Delegate | 55 | Calendar | Create New Appointment | Existence of new |
| Application | | | | element |
| Delegate | 56 | Calendar | Modify Appointment Subject | Subject |
| Application | | | Field | |

The three examples that follow illustrate different formats in which some of the tests of Table 1 can be implemented (e.g., portions of the set of instructions 150). The first example is an example of a set of instructions (e.g., a portion of application 150d) to execute test number 30 of Table 1 on a desktop computing device (e.g., 140). This exemplary set of instructions uses a Microsoft® API that employs objects in the Outlook® Object Model (OOM). As indicated in Table 1, test 30 creates a new task element on a handheld device 105 and this sample code verifies that the task was synchronized (e.g., added to) the PIM application executing on the desktop computing device 140. This sample code for test number 30 verifies that some of the parameters of the task element created on the handheld device 105 and synchronized with the desktop computing device 140 were set to predefined values as follows: the subject of the task is set to “Individual Task”; the status of the task is set to not started (e.g., rTask.Status=olTaskNotStarted); the body of the task is set to “Task synchronize Handheld to Desktop”; and, the importance of the task is set normal (e.g., rTask.Importance=olImportanceNormal). If the synchronized task has the predefined values, then the sample code indicates that the test was successful. If one or more of the values of the synchronized task are not set to the predefined values, of if the task does not exist, then the sample code indicates that the test was not successful.

Private Sub Command 100_Click( )
Set rApplication = New Outlook.Application
Set rNameSpace = rApplication.GetNamespace(“MAPI”)
Set rFolder = rNameSpace.GetDefaultFolder(olFolderTasks)
MSubject = “Individual Task”
bool = False
For cnt = 1 To rFolder.Items.Count

Set rTask = rFolder.Items.Item(cnt)
If ((rTask.Subject = MSubject) And _{—}

(rTask.Status = olTaskNotStarted) And _{—}
(rTask.Body = “Task synchronize Handheld to Desktop Outlook Application”) And _{—}
(rTask.Importance = olImportanceNormal)) Then

MsgBox “Task Created through Handheld” & vbCrLf & vbCrLf & “Test Successful!!”
Command100.BackColor = &HC000&
bool = True
Exit For

End If
Set rTask = Nothing

Next
If (bool = False) Then

MsgBox “Task Not Created through BlackBerry ®” & vbCrLf & vbCrLf & “Test Failed!!”
Command100.BackColor = &HFF&

End If
Call Cleanup
End Sub

The second example is an example of a set of instructions (e.g., a portion of application 150c) to execute test number 43 of Table 1 on a handheld device (e.g., 105). This exemplary set of instructions uses JAVA classes. As indicated in Table 1, test number 43 generates a new calendar element on the handheld device 105. This sample code for test number 43 sets some of the parameters of the calendar element to predefined values as follows: the date of the appointment is set to the day after the day the test is performed (e.g., Calendar.DATE)+1); the time of the appointment is set to 3:00 pm (e.g., Calendar.HOUR_OF_DAY, 15); the summary of the appointment is set to “Individual Test Meeting”; the location of the appointment is set to “Conference Room 10-3”; and, the length of the appointment is set to 30 minutes (e.g., start.getTime()+1800000).

public void createAppointment(BasicEditField txtfield)

{

try
{

eventList = (EventList)PIM.getInstance( ).openPIMList(PIM.EVENT_LIST,

PIM.READ_WRITE);

event = eventList.createEvent( );
Calendar cal = Calendar.getInstance( );
cal.set(Calendar.DATE,cal.get(Calendar.DATE)+1);
cal.set(Calendar.HOUR_OF_DAY,15);
cal.set(Calendar.MINUTE,0);
Date start = cal.getTime( );
if (eventList.isSupportedField(Event.SUMMARY)) {

event.addString(Event.SUMMARY, Event.ATTR_NONE, “Individual Test

Meeting”);

}
if (eventList.isSupportedField(Event.LOCATION)) {

event.addString(Event.LOCATION, Event.ATTR_NONE, “Conference Room

10-3”);

}
if (eventList.isSupportedField(Event.START)) {
event.addDate(Event.START, Event.ATTR_NONE, start.getTime( ));
}
if (eventList.isSupportedField(Event.END)) {
event.addDate(Event.END, Event.ATTR_NONE, );//appointment for 30 minutes.
}
// by default the alarm is set to 15 min before the event.
if(event.isModified( ))
{

event.commit( );
System.out.println(“Appointment has been created for tomorrow 3pm”);
txtfield.insert(“Appointment has been created for tomorrow 3pm”);

}

}
catch (PIMException e)
{

e.printStackTrace( );
return;

}
catch (IllegalArgumentException e)
{

e.printStackTrace( );
System.out.println(e.getMessage( ));

}

}

The third example is an example of a set of instructions (e.g., a portion of application 150d) to execute test number 50 of Table 1 on a desktop computing device (e.g., 140). This exemplary set of instructions uses a Microsoft® API that employs a library of Collaboration Data Objects (CDOs), referred to as CDO 1.21. As indicated in Table 1, test number 50 generates a new calendar element on the desktop computing device 105. This sample code for test number 50 sets some of the parameters of the calendar element to predefined values as follows: the date of the appointment is set to the day after the day the test is performed (e.g., startTime=Date+1 +#3:00:00 PM#); the time of the appointment is set to 3:00 pm (e.g., startTime=Date+1 +#3:00:00 PM#); the length of the appointment is set to 30 minutes (e.g., endTime=Date+1 +#3:30:00 PM#); the subject of the appointment is set to “Create Appointment”; the location of the appointment is set to “Marlborough”; The text of the appointment is set to “Meeting regarding certification”; a reminder is set (ReminderSet=True);and, the reminder is set for 15 minute before the start time (e.g., ReminderMinutesBeforeStart=15).

Private Sub Command158_Click( )
Set oFolder = CdoSession.GetDefaultFolder(CdoDefaultFolderCalendar)
Set oMessages = oFolder.Messages
Set oAppointment = oMessages.Add
Set oRecipients = oAppointment.Recipients
With oAppointment

.MeetingStatus = CdoNonMeeting
.Subject = “Create Appointment”
.startTime = Date + 1 + #3:00:00 PM#
.endTime = Date + 1 + #3:30:00 PM#
.Location = “Marlborough”
.Text = “Meeting regarding certification”
.ReminderSet = True
.ReminderMinutesBeforeStart = 15

End With
oAppointment.Update
MsgBox “Appointment Created..” & vbCrLf & vbCrLf &
“Test Successful!!”
Command158.BackColor = &HC000&
Call Cleanup
End Sub

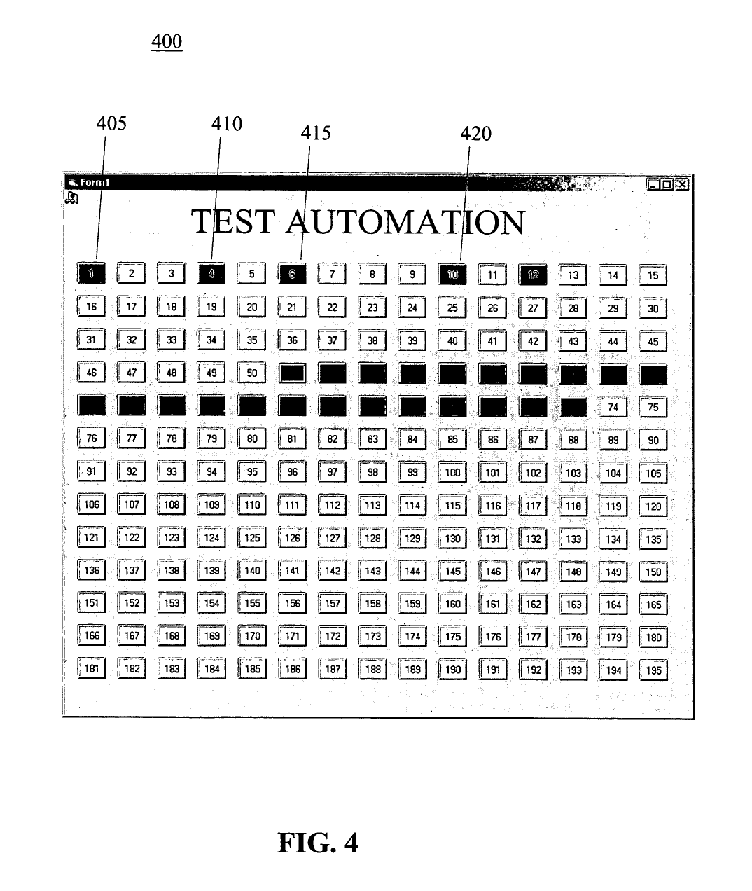

FIG. 4 illustrates a screenshot of a graphical user interface (GUI) 400 that the desktop computing device 140 can display to a user. The GUI 400 represents a test suite of 195 tests, where some of the tests represent the creation or modification of elements on the computing device 140 and some of the tests represent the verification of the creation or modification of elements on the handheld device 105 and synchronization with the desktop computing device 140. Although Table 1 does not represent a test suite of 195 tests, the tests of Table 1 are used in the description of the GUI 400 to provide illustrative examples.

To perform a test, the user can click on a button on the GUI 400 and the desktop computing device 140 executes the test associated with that test number. If the user selects a button labeled “1” 405 (e.g., moves a cursor over a button of the GUI 400 using a mouse and clicks a button on the mouse), the desktop computing device 140 executes a set of instructions (e.g., a portion of 150d) to perform test number 1. Using Table 1 for example, executing test number 1 causes an email to be generated on the desktop computing device 140 with a specific addressee in the “To” field. When test 1 has been executed successfully (e.g., the email was generated on the desktop computing device 140 with the correct value in the “To” field), the GUI 400 indicates this by, for example, changing the background color of the button labeled “1” 405.

In some examples, tests are combined. For example, if the user selects the button labeled “1” 405, the desktop computing device 140 executes a set of instructions (e.g., a portion of 150d) to perform test numbers 1,4 and 6. Using Table 1 for example, executing test numbers 1,4, and 6 causes an email to be generated on the desktop computing device 140 with a specific addressee in the “To” field, a value of “Private” for the sensitivity parameter, and an attachment of a spreadsheet document. When tests 1,4, and 6 have been executed successfully (e.g., the email was generated on the desktop computing device 140 with the correct value in the “To” field and the sensitivity field and has a spreadsheet document attachment), the GUI 400 indicates this by, for example, changing the background color of the button labeled “1” 405, the button labeled “4” 410, and the button labeled “6” 415. In other examples, the user can select the button labeled “1” 405 and the desktop computing device 140 executes all of the tests in the suite in some order, which does not have to be sequential. In other examples, there can be a button labeled “ALL” or something similar (not shown) that causes the desktop computing device 140 to execute all of the tests in the suite in some order, which does not have to be sequential.

In addition to indicating the successful (or unsuccessful) execution of one or more tests (e.g., creation and/or modification of PIM and/or email elements), the GUI 400 also indicates the successful (or unsuccessful) verification of the synchronization on the desktop computing device 140 of elements created/modified on the handheld device 105. Using Table 1 for example, test 10 includes creating an email on the handheld device 105 with a value of “High” for the importance parameter. If a user selects a button labeled “10” 420 in the GUI 400, the desktop computing device 140 verifies that an email was received from the handheld device 105 and that the importance parameter of that received email is set to value of “High”. If that test is verified, the button labeled “10” 420 indicates the successful verification by, for example, changing the background color to green (or to red if the verification is unsuccessful).

In addition to displaying the successful (or unsuccessful) execution and verification of tests on performed on the desktop computing device 140, the GUI 400 can also display the successful (or unsuccessful) execution and verification of tests performed on the handheld device 105. In such examples, different colors are used to indicate the successful or unsuccessful execution of a test (e.g., creation or modification of an element). Different colors can also be used to indicate the device on which the test is performed. To indicate information from the handheld device 105, the desktop computing device 140 can receive special status elements from the handheld device 105. These special status elements can be, for example, calendar elements or email elements with special text in the subject or body to indicate the test and its status. To provide redundancy in case of failures multiple status elements (e.g., calendar and email elements) can be used together. In other examples, timing can be used to perform tests. For example, the test suite can be started on the desktop computing device 140 and the handheld device 105 in a short period (e.g., within 3 minutes of each other). Each device estimates the time for the other device to perform a test (e.g., generate or modify an element) and when that time expires, the device performs a verification. Using Table 1 for example, the desktop computing device 140 may take 2 minutes to perform tests 1-6 and synchronize the created emails with the handheld device 105. Similarly, the handheld device 105 may take 2 minutes to perform tests 7-13 and synchronize the created/modified emails with the desktop computing device 140. After taking the 2 minutes to perform the test, plus an additional time for the difference in starting the tests on the two devices (e.g., the three minutes), each device would verify the tests of the other device. In other words, after the five minutes, the handheld device 105 verifies test 1-6 and the desktop computing device 140 verifies the tests 7-13. Such an approach can be used for any grouping of tests.

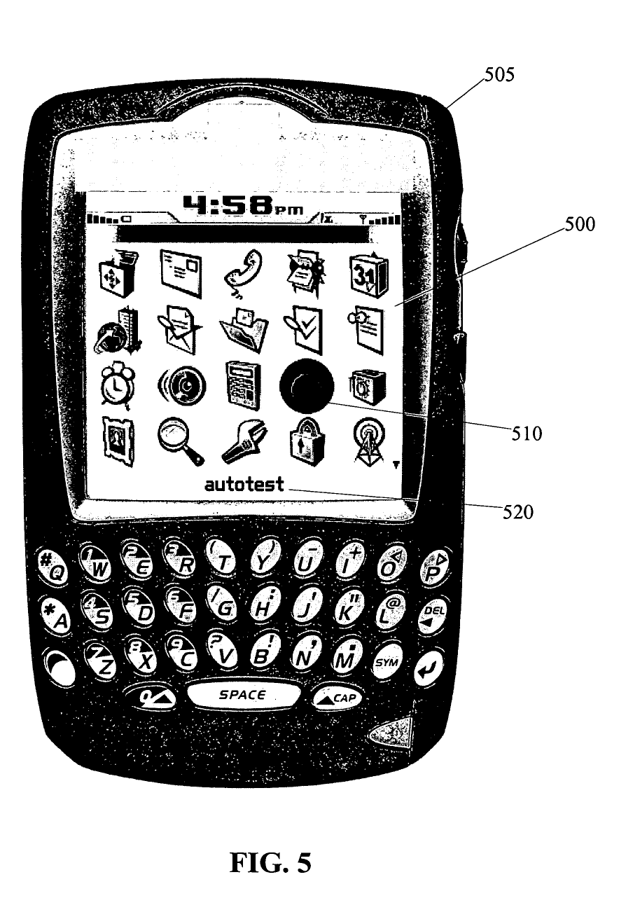

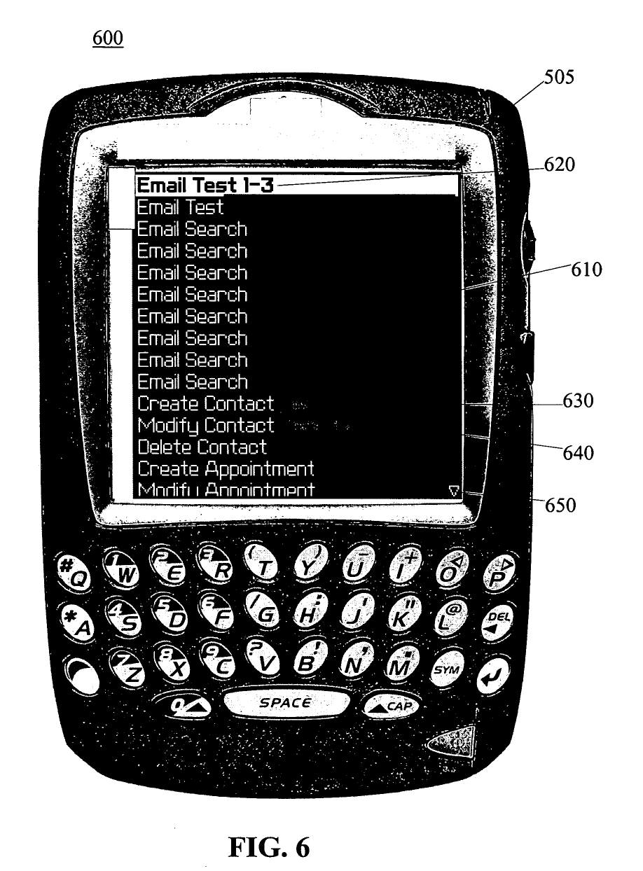

FIG. 5 shows a screen shot 500 displayed on a handheld device 505. The screenshot includes an icon 510 used to initiate the tests on the handheld device 505. A description 520 displays to the user a description of icon 510 (e.g., “autotest”) when the user highlights the icon 510. When the user selects the icon 510, the handheld device 505 displays another screen. For example, FIG. 6 illustrates a screen shot of a portion of a graphical user interface (GUI) 610 that a user can use on the handheld device 505 to navigate through, execute and determine the status of any of the tests. Although the GUI 610 is not based on the tests described in Table 1, the Table 1 tests can be used in connection with FIG. 6 to provide illustrative examples. For example, tests 1-3 of Table 1 are executed on the desktop computing device 140 and cause the generation of an email with specific “To” and “CC” addressees, and a value of “personal” for the sensitivity parameter. Using the GUI 610, a user can select (e.g., highlight and click) an “Email Test 1-3” entry 620 on the handheld device 505. Upon selection, the handheld device 505 verifies that an email generated by tests 1-3 (e.g., in the case of the Table 1 tests, an email with specific “To” and “CC” addressees, and a value of “personal” for the sensitivity parameter) is included in the email on the handheld device 505 and has the predefined values. If the verification is successful, the handheld device 505 can so indicate by, for example, displaying the text “Tests 1-3 Successfully Verified” in a text box over the GUI 610. As described above, the handheld device can also send an element (e.g., email) to the desktop computing device 140 so that the results of the verification on the handheld device 505 can be displayed in the GUI 400 of the desktop computing device 140.

Using the GUI 610, the user can select (e.g., highlight and click) to execute and verify additional tests. For example, the user can select a “Create Contact [Test 17]” entry 630. Selection of the “Create Contact [Test 17]” entry 630 causes the handheld device 505 to generate a new contact, for example as described in test 17 of Table 1. The user can select a “Modify Contact [Tests 18-21]” entry 640. Selection of the “Modify Contact [Tests 18-21]” entry 640 causes the handheld device 505 to modify certain parameters of the new contact, for example as described in tests 18-21 of Table 1. If the user wants to access additional tests, the user can scroll the list in the GUI 610 using a scroll bar 650. In other examples, there can be an entry labeled “ALL Tests” or something similar (not shown) that causes the handheld device 505 to execute all of the tests in the suite in some order, which does not have to be sequential. As described above, the test sequence can also include interaction with the desktop computing device 140, so that with one or more clicks, the entire test suite can be performed (including verification) and the results displayed for the user.

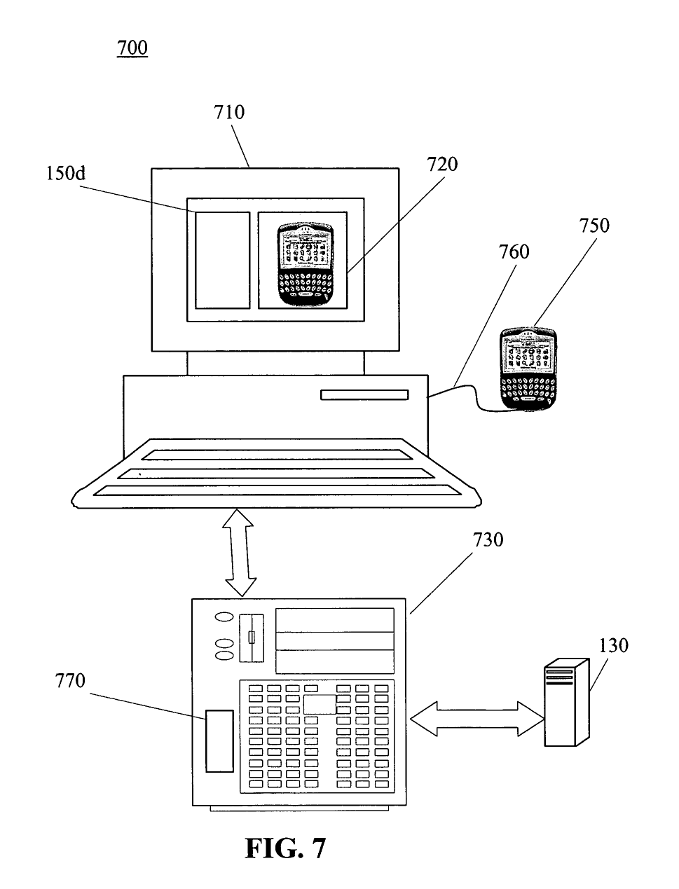

FIG. 7 illustrates an exemplary system 700 of different configurations for automated testing using simulated devices and different networks. The system 700 includes a desktop computing device 720 that includes a simulated handheld device application 720. The simulated handheld device application 720 can display a picture of the simulated handheld device on a display of the desktop computing device 710, including a simulated screenshot of the simulated handheld device. In such a configuration, the simulated handheld device application 720 acts and is used in the same way as described above for any of the handheld devices 105. The simulated handheld device application 720 uses its host, the desktop computing device 710, to communicate with the one or more network servers 730 to synchronization email and PIM data with the desktop computing device 710, similar to how an actual device communicates with those servers. In such a configuration, the network comprises the simulated handheld device, the desktop computing device 710, and the one or more network servers 730 with which the desktop computing device 710 communicates.

In another illustrated configuration, the system 700 includes a handheld device 750 that is in communication with the desktop computing device 710 via a cable 760 (e.g., a Universal Serial Bus (USB) cable). In such a configuration, the desktop computing device 710 includes an application (not shown) that manages the synchronization of data (emails, PIM data, downloads (applications, photos, music), and the like) between the handheld device 750 and the desktop computing device 710 when the two are in communication with each other via cable 760. To conserve bandwidth of a corporate network, some PIM elements, such as memopad may only be synchronized via the wired connection. In such cases, the tests that involve those elements (e.g., tests 40-42 of Table 1) are executed and verified when the handheld device 750 and the desktop computing device 710 are in communication with each other via cable 760. In such a configuration, the network comprises the handheld device 750, the desktop computing device 710, and the cable 760 over which the desktop computing device 710 communicates. In other examples, the cable 760 can be replaced with short range wireless technology, such as infrared technology, Bluetooth® technology, radio frequency (RF) technology, and the like.

In another illustrated configuration, the system 700 includes one or more servers 730 that include a simulated server application 770. The simulated server application 770 can simulate different server and/or network configurations, so that a user can test a handheld device (or simulated handheld device) over several different server/network configurations before actual deployment and implementation. For example, in a network supporting BlackBerry® devices, an Email Server Simulator (ESS) can be used instead of a BES. The ESS sends and receives email to and from a Microsoft® Exchange Server.

Although the systems 100 and 700 illustrate one desktop computing device, other examples can use multiple desktop computing devices. For example, a user can test the ability to send emails to multiple addressees. Or, to test delegate features, another desktop computing device associated with a delegate for test purposes can be used. Although some examples above reference specific brands of devices and/or operating systems, the invention is not so limited. Some other examples of the handheld devices that can be used include: any of the BlackBerry® devices manufactured and/or sold by RIM, Ltd., any of the iPAQ Pocket PC™ devices manufactured and/or sold by Hewlett Packard (HP) (Originally Compaq until HP merged in 2002), any of the devices manufactured and/or sold by Palm, Inc., including the Tungsten™ handheld devices, the LifeDriveTm handhelds, the Treo™ handhelds and the Zire™ handhelds, the Wizard™ (OZ-290HII) handheld and Zaurus™ devices manufactured and/or sold by Sharp, the CLIE® devices manufactured and/or sold by Sony, the Dana™ wireless devices manufactured and/or sold by AlphaSmart, Inc., the Axim™ devices manufactured and/or sold by Dell, the SCH-i730 handheld and SPH i700 handheld manufactured and/or sold by Samsung, the Sidekick® II manufactured and/or sold by T-Mobile, the Pocket LOOX handhelds manufactured and/or sold by Fujitsu Siemens Computer, the MPx220 handheld device manufactured and/or sold by Motorola, the SMT5600 handheld device manufactured and/or sold by Audiovox, the 9300 smartphone device manufactured and/or sold by Nokia, the SX66 PDA phone manufactured and/or sold Siemens and Cingular, and the P910a PDA phone manufactured and/or sold by Sony Ericsson. Some examples of handheld device operating systems (OS) that can be used are: Palm® OS by Palm, Inc., Windows Mobil® (Pocket PC) OS, (based on the Windows® CE kernel) by Microsoft, BlackBerry® OS by Research In Motion, Ltd., Symbian OS™ by Ericsson, Panasonic, Nokia, Samsung, Siemens and Sony Ericsson. Also, many operating systems are based on the Linux kernel. These include: GPE - Based on GTK+/X11, and OPIE/Qtopia—based on Qt/E. Qtopia is developed by Trolltech and OPIE is a fork of Qtopia developed by volunteers. Some examples of desktop applications that can be used are Microsoft® Outlook® software and IBM® messaging and PIM software, such as Lotus Notes®.

The above-described processes can be implemented in digital electronic circuitry, in computer hardware, firmware, software, or in any combinations of them. The implementation can be as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed over multiple sites and interconnected by a communication network.

Method steps can be performed by one or more programmable processors executing a computer program to perform functions of the invention by operating on input data and generating output. Method steps can also be performed by, and apparatus can be implemented as, special purpose logic circuitry, e.g., an FPGA (field programmable gate array) or an ASIC (application-specific integrated circuit). Modules and software agents can refer to portions of the computer program and/or the processor/special circuitry that implements that ftnctionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Data transmission and instructions can also occur over a communications network. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the above described processes can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The above described processes can be implemented in a distributed computing the system that includes a back-end component, e.g., as a data server, and/or a middleware component, e.g., an application server, and/or a front-end component, e.g., a client computer having a graphical user interface and/or a Web browser through which a user can interact with an example implementation, or any combination of such back-end, middleware, or front-end components. The components of the system can be interconnected by any form or medium of digital data communication, e.g., a communication network.

Examples of communication networks include a local area network (LAN), a wide area network (WAN), e.g., the Internet, and/or a metropolitan area network (MAN) and include both wired and wireless networks or portions thereof. A communications network can be, for example, part of the Public Switched Telephone Network (PSTN) and/or a packet-based network and can be public or private.

The computing the system can include clients and servers. A client and server are generally remote from each other and typically interact through a communication network. The relationship of client and server arises by virtue of computer programs running on the respective computers and having a client-server relationship to each other.

Unless explicitly stated otherwise, the term “or” as used anywhere herein does not represent mutually exclusive items, but instead represents an inclusive “and/or” representation. For example, any phrase that discusses A, B, or C can include any of A, B, C, AB, AC, BC, and ABC. In many cases, the phrase A, B, C, or any combination thereof is used to represent such inclusiveness. However, when such phrasing “or any combination thereof” is not used, this should not be interpreted as representing a case where “or” is not the “and/or” inclusive case, but instead should be interpreted as a case where the author is just trying to keep the language simplified for ease of understanding.

The invention has been described in terms of particular embodiments. The alternatives described herein are examples for illustration only and not to limit the alternatives in any way. Other embodiments are within the scope of the following claims.

What is claimed is:

1. A computerized method comprising:
executing on a handheld device a first predefined test to generate a first element with a first predefined value for a first parameter associated with the first element;
transmitting the first element over a communication network to a desktop computing device; and
verifying receipt of the first element at the desktop computing device and that the first parameter associated with the first element has the first predefined value.

2. The method of claim 1, further comprising:
executing on the desktop computing device a second predefined test to generate a second element with a second predefined value for a second parameter associated with the second element;
transmitting the second element over a network to the handheld device; and
verifying receipt of the second element at the handheld device and that the second parameter associated with the second element has the second predefined value.

3. The method of claim 1, further comprising:
executing on the handheld device a second predefined test to generate a second element with a second predefined value for a second parameter associated with the second element;
transmitting the second element over a network to desktop computing device; and
verifying receipt of the second element at the desktop computing device and that the second parameter associated with the second element has the second predefined value.

4. The method of claim 1, further comprising:
executing on the handheld device a second predefined test to modify the first element by changing the first parameter associated with the first element to a second predefined value;
transmitting the modified first element over a network to desktop computing device; and
verifying receipt of the modified first element at the desktop computing device and that the first parameter associated with the first element has the second predefined value.

5. The method of claim 4, wherein the first element comprises a calendar entry and the first parameter is associated with time.

6. The method of claim 1, further comprising indicating to the desktop computing device that the first predefined test has been executed.

7. The method of claim 1, wherein indicating further comprises employing a graphical user interface on the desktop computing device.

8. The method of claim 1, wherein the first element comprises an email, a contact, a task, a note, a calendar entry, or any combination thereof.

9. The method of claim 1, wherein the first element comprises an element of a MICROSOFT OUTLOOK application program.

10. The method of claim 1, wherein the first predefined test comprises a platform neutral instruction set.

11. The method of claim 1, wherein the first predefined test comprises a JAVA applet.

12. The method of claim 1, wherein the first predefined test comprises an instruction set to interface with an application program interface (API) of an operating system included on the handheld device.

13. The method of claim 12, wherein the operating system (OS) included on the handheld device comprises Palm OS, WINDOWS MOBILE (Pocket PC) OS, BLACKBERRY OS, SYMBIAN OS, or any combination thereof.

14. The method of claim 1, wherein verifying includes interfacing with an application program interface (API) of an application program included on the desktop computing device, the application program being associated with the first element.

15. The method of claim 1, wherein the handheld device comprises a RIM BLACKBERRY device, a PALM PDA device, a mobile telephony device, a handheld device simulator application program, or any combination thereof.

16. The method of claim 1, wherein the network comprises a server represented using a server simulator application program.

17. The method of claim 1, further comprising displaying the results of verifying, employing a graphical user interface on the desktop computing device, the handheld device, or both.

18. A system comprising:
a desktop computing device configured to:
receive a first element over a communication network from a handheld device, the first element being generated from a first predefined test executed on the handheld device and having a first predefined value for a first parameter associated with the first element; and
verify receipt of the first element at the desktop computing device and that the first parameter associated with the first element has the first predefined value.

19. A system comprising:
a handheld device configured to:
execute a first predefined test to generate a first element with a first predefined value for a first parameter associated with the first element;
transmit the first element over a communication network to a desktop computing device; and
verify receipt of a second element generated by the desktop computing device and that a second parameter associated with the second element has a second predefined value.

20. A system comprising:
a means for executing on a handheld device a first predefined test to generate a first element with a first predefined value for a first parameter associated with the first element;
a means for transmitting the first element over a communication network to a desktop computing device; and
a means for verifying receipt of the first element at the desktop computing device and that the first parameter associated with the first element has the first predefined value.

21. A computer program product, tangibly embodied in an information carrier, for automated testing of a handheld over a network, the computer program product including instructions being operable to cause data processing apparatus to:
execute on a handheld device a first predefined test to generate a first element with a first predefined value for a first parameter associated with the first element;
transmit the first element over a communication network to a desktop computing device; and
verify receipt of the first element at the desktop computing device and that the first parameter associated with the first element has the first predefined value.
